(19) United States
(12) Patent Application Publication
(10) Pub. No.: US 2001/0053435 A1
(43) Pub. Date: Dec. 20, 2001

(54) Recording material

(75) Inventors: Naoyuki Ishii, Fuji (JP); Hirotaka Yamamoto, Fuji (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Nisshinbo Industries, Inc., Tokyo (JP)

(21) Appl. No.: 09/837,184

(22) Filed: Apr. 19, 2001

(30) Foreign Application Priority Data
Apr. 19, 2000 (JP) 2000-117675

(51) Int. Cl. B41M 5/00

(52) U.S. Cl. 428/195

(57) ABSTRACT

The present invention discloses a recording material in which an ink receiving layer containing, as main components, a binder resin and microparticle silica is provided on a substrate, wherein a ratio F/R, which is a ratio of a solid content weight F of the microparticle silica in the ink receiving layer to a solid content weight R of the binder resin, is in the range of 2.0 to 7.0 and a dicyandiamide polycondensate is contained in the ink receiving layer. The recording material of the present invention has excellent water proof and light resistance properties and allows printing of full-color images thereon without the patterns, colors, texture of the substrate material surface being marred even when an ink receiving layer is provided on the substrate. The recording material can be suitably used not only in the ink jet type recording but also in the offset printing.

### BACKGROUND OF THE INVENTION

1. Field of the Invention

The present invention relates to a recording material which has excellent water proof and light resistance properties and allows printing of full-color images thereon without the patterns, colors, texture of a substrate material surface being marred even when an ink receiving layer is provided on the substrate. The present invention more specifically relates to a recording material which can suitably be used not only in the ink-jet type recording but also in the offset printing.

2. Description of the Related Art

As a printing recording method, the recording methods such as the melting type thermal transfer, sublimation type thermal transfer, electrophotography and inkjet printing are well known in recent years, in addition to the conventional offset printing method. Among the new printing recording methods as described above, the inkjet recording method is now rapidly widening its application to various purposes as a method of obtaining hardcopies of characters, various patterns and color images, because the method allows high-speed and low-noise printing, is easily adapted to multi-color and large image-size printing, allows flexible change in recording patterns, and does not necessitate development and fixing.

In the inkjet recording method, extremely small droplets of ink are injected at a high speed from a nozzle of a printer onto a recording material, so that the ink is attached to a recording surface and recording of image, characters and the like are effected. Accordingly, the recording materials which are suitable for use in the inkjet recording method have especially been developed.

On the other hand, the aforementioned conventional offset printing method, as a method having an advantage which is different from that of the inkjet recording material, requires recording materials particularly suitable for the use in the offset printing method. In other words, the recording materials for the inkjet recording method cannot simply be used for the offset printing method.

If the conventional recording material for the inkjet recording method is used for the offset printing, the following problems will arise.

a) It takes significantly long time before the ink is set.

b) The resulting print is poor in smoothness and the glossiness of the printing portion is insufficient.

c) As the material is porous, the material exhibits poor friction resistance and easily loses the upper surface thereof during the offset printing because the printing plate takes the upper surface away.

d) As the pigments having high oil-absorption property are coated on the material, the material rapidly absorbs only vehicles in the ink during the offset printing and thus the transfer of the pigments in the ink is disturbed.

e) The cationic-state inducing agent contained in the recording material makes the hydrophobic portion of the plate of the offset printing hydrophilic, whereby the ink is emulsified.

In short, the printing materials suitable for the use in the offset printing are different from those suitable for the use in the inkjet recording method at this moment, and a printing material which is suitable for both methods has not been developed yet.

In the conventional recording material for the inkjet recording method, there exist two different types: one type in which characters, images and the like printed in the ink receiving layer are directly read in the surface of the material; and the other type in which the opacity of the substrate and that of the ink receiving layer are both lowered so that the light transmittance of the material is increased as a whole, whereby the material can be used for an optical device such as a slide and an OHP (overhead projector). However, there has not been developed such a recording material for the inkjet recording method, which not only has excellent water proof and light resistant properties but also in which only the opacity of the ink receiving layer is decreased so that the patterns, colors and texture of the substrate surface can be seen at the surface of the recording material through the ink receiving material.

For example, in Japanese Patent Application Laid-Open No. 7-329412, there is disclosed a coating type inkjet recording sheet in which the ink receiving layer is provided, by coating, in one side surface of the substrate which is mainly constituted of wood pulp. According to the disclosure, the ink absorption property, color developing property, water proof property and the like are well achieved by having the ink receiving layer contain a hydrophilic resin and synthetic silica whose primary particles diameter is a few micron. However, in this case, as the opacity of the ink receiving layer itself, which is provided by coating, is 50% or more, the colors, patterns and the like of the wood pulp surface as the substrate are not visible at the surface of the sheet surface at all.

In addition, Japanese Patent Application Laid-Open Nos. 7-314884 and 7-285265 disclose a sheet for recording provided with a highly transparent ink receiving layer having excellent ink absorption property which is achieved by the combination of highly transparent and water absorbing resins and the like, is provided on a plastic film substrate. However, as the resins themselves in the ink receiving layer absorb water and swell, the ink receiving layer exhibits quite poor water proof property. Further, there arises another problem that printing by using a common ink is virtually impossible in this recording sheet due to lack of minute voids in the recording sheet.

Providing such a highly transparent ink receiving layer as disclosed in Japanese Patent Application Laid-Open Nos. 7-314884 and 7-285265, in place of the highly opaque ink receiving layer of the inkjet recording sheet disclosed in JP-A 7-329412, on the substrate does result in some visibility, at the sheet surface, of the colors, patterns and the like of the substrate surface. However, in this case, the water proof property and the light resistant property significantly deteriorate. In addition, there arises a problem that, as the way thereof of receiving ink is different from that of the offset printing, the product cannot be used for the offset printing method at all.

### SUMMARY OF THE INVENTION

Therefore, the conventional recording material for the inkjet recording can be used only for the inkjet recording method and cannot be used as the recording material for the offset printing method. In consideration of this problem, an object of the present invention is to provide a novel recording material which is applicable to both of the aforementioned two printing methods, makes patterns, colors and texture of a substrate surface visible at the material surface by decreasing the opacity of an ink receiving layer, and thus achieves, in collaboration with characters, images and the like printed in the ink receiving layer, an unconventional manner of expression in printing.

In order to solve the aforementioned problems, in the structure of the present invention, a recording material in which an ink receiving layer containing, as main components, a binder resin and microparticle silica is provided on a substrate is characterized in that a ratio F/R, which is a ratio of a solid content weight F of the microparticle silica in the ink receiving layer to a solid content weight R of the binder resin, is in the range of 2.0 to 7.0 and a dicyandiamide polycondensate is contained in the ink receiving layer.

Specifically, the inventors of the present invention have assiduously studied in order to develop a recording material, which can be adapted to both the inkjet recording method and the offset printing method, by improving the conventional recording material for the inkjet recording method. As a result, they have discovered that:

1) The absorption property of ink for the offset printing is improved by using microparticle silica, whereby the time required for the ink to set is shortened.

2) As microparticle silica has a relatively small particle diameter, the smoothness of a product surface is improved, whereby the glossiness of the printing portion of the offset prints is improved.

3) By making the ink receiving layer thin (2.0 to 10.0 g/m²), the friction resistance property thereof is improved.

4) By lowering the ratio F/R, which is the ratio of the solid content weight F of the microparticle silica in the ink receiving layer to the solid content weight R of the binder resin to 7.0 or less, the absorption of vehicles in the ink is suppressed and the ink-transfer problem can be solved.

5) By using a dicyandiamide polycondensate as the cationic-state inducing agent, the ink is significantly prevented from being emulsified.

The inventors have also discovered that:

6) By employing the aforementioned structures 1) to 5), not only the water proof, light resistance and ink absorbing properties are improved, but also the opacity of the ink receiving layer can be set low due to the use of microparticle silica. As a result, the colors, patterns and texture of the substrate surface can be made visible at the sheet surface.

The present invention has been completed on the basis of these discoveries.

In addition to the aforementioned structure, the recording material of the present invention may have a structure in which the dicyanamide polycondensate is a polyamine-based condensate, a structure in which the average particle diameter of primary particles of microparticle silica is 10 nm or less and the value of specific surface area according to BET is in the range of 250-450 m²/g, and a structure in which the binder resin is a polyvinyl alcohol resin.

### DESCRIPTION OF THE PREFERRED EMBODIMENT

The present invention will be described in detail according to a preferred embodiment hereinafter.

A recording material of the present invention has a structure in which an ink receiving layer containing as main components a binder resin and microparticle silica is provided at least one side of a substrate.

Examples of the substrate to be used in the recording material of the present invention include woodfree paper, intermediate-grade paper, groundwood paper, simili paper, art paper, slightly coated paper, thin paper, fancy paper, non-wood paper, foreign materials-mixed paper, chemical pulp paper, a material produced by subjecting any of the aforementioned papers to the emboss processing or the like to provide patterns thereon, colored paper containing dyes or pigments added thereto, or the like. The present invention most preferably exhibits the characteristics thereof when paper having colors or patterns provided thereon is employed.

Microparticle silica contained in the ink receiving layer of the recording material of the present invention is a type of silica which is produced by combusting silicon tetrachloride with hydrogen and oxygen, i.e., by the gas phase method. Examples of binder resin contained in the ink receiving layer include resins such as polyvinyl alcohol, gelatin, sodium alginate, polyvinylpyrrolidone, polyethylene oxide, and hydroxyethylcellulose. Among these examples, polyvinyl alcohol can be preferably used. A highly transparent resin is preferably used as the binder resin. In the present invention, microparticle silica is used so that the ink absorption property is enhanced without deteriorating the transparency of the ink receiving layer.

In the recording material of the present invention, the opacity of the ink receiving layer is decreased, so that the colors, patterns and texture of the substrate surface can be seen at the material surface. With respect to the opacity of the ink receiving layer, the value thereof measured by a measuring method according to JIS-P8138 is preferably 35% or less. Here, the opacity of the ink receiving layer is, according to the standard, the opacity measured as a whole including a transparent PET substrate whose opacity is in the range of 13.0 to 16.0%, on which an ink receiving layer is provided. The method of testing opacity according to JIS-P8138 (the testing method of determining the opacity of paper) is a testing method which specifically includes the steps of: applying a white standard plate on the back side of a sample and measuring the reflectance of the sample by using a green filter; applying a black standard plate on the back side of a sample and measuring the reflectance of the sample by using a green filter; calculating the ratio (%) of the reflectance of the latter with respect to the reflectance of the former; and determining, for example, that the sample whose ration is 100% is completely opaque paper.

In the recording material of the present invention, the ratio F/R, which is the ratio of a solid content weight F of the microparticle silica in the ink receiving layer to a solid content weight R of the binder resin, is in the range of 2.0 to 7.0. When the ratio F/R is less than 2.0, the ink absorption capacity is insufficient and the ink may flow out. On the other hand, when the ratio F/R is more than 7.0, the surface layer becomes brittle. Accordingly, the ratio F/R is preferably in the range of 3.0 to 6.0.

Next, the ink receiving layer of the recording material of the present invention contains a dicyandiamide polycondensate, in addition to the microparticle silica and the binder resin described above. Examples of the dicyandiamide polycondensate include a dicyandiamide/formalin polycondensate, a dicyandiamide/diethylenetriamine polycondensate. Among these examples, the polyamine-based compounds are preferable.

In the recording material of the present invention, when the average particle diameter of the primary particles of microparticle silica in the ink receiving layer is 10 nm or less and the value of specific surface area according to BET is in the range of 250 to 450 m²/g, an adequate hardness of the surface layer is obtained, thereby enhancing the ink absorbing effect. Here, the BET method is one of the methods of measuring surface area of powder body by the gas phase adsorption method. Specifically, the BET method is a method in which the total surface area possessed by 1 g of the sample, i.e., specific surface area, is obtained from the adsorption isotherm line. When the diameter of the primary particle of microparticle silica is more than 10 nm, the surface layer becomes brittle. When the specific surface area is less than 250 g/m², the rate of ink absorption is slow, resulting in deterioration of drying property.

Next, the amount of coating of the ink receiving layer in the recording material of the present invention is, in the dry weight, preferably 2.0 to 10.0 g/m², and more preferably 3.0 to 5.0 g/m². In addition, the drying temperature is in the range of approximately 80 ° C. to 120 ° C.

Further, examples of the method of coating the ink receiving layer include known reverse roll coating, air knife coating, gravure coating, blade coating, comma coating and the like.

As described above, according to the recording material of the present invention, as the opacity of the ink receiving layer is low, printing of full-color images having excellent water proof and light resistance properties on the recording material without marring the patterns, colors, texture of the substrate material surface is possible even when an ink receiving layer is provided on the substrate. In addition, as polyvinyl alcohol, a dicyandiamide-polycondensate and microparticle silica are used in combination in the ink receiving layer, excellent water proof property is achieved not only in the printing portions but also in the non-printing portions.

Further, according to the recording material of the present invention, as the ink receiving layer has numerous minute voids (pores) due to microparticle silica, although the ink receiving layer still remains transparent, excellent ink absorption rate and drying property are obtained.

Accordingly, due to the reasons as described above, the recording material of the present invention is applicable not only to the inkjet recording method but also to the offset printing method using a common printing ink. As a result, there is no longer necessary to prepare different recording materials for each method as is conventionally done, whereby the printing cost is significantly reduced. In addition, as microparticle silica is contained in the ink receiving layer, the ink does not sink so much, whereby an effect of improving glossiness of the print and the printing concentration is also achieved. Further, flexible change in the printing method, for example, information which is unlikely to change is printed beforehand by the offset printing method and information which may change is thereafter printed by the inkjet recording method, is possible.

Next, examples and comparative examples of the recording material of the present invention will be described hereinafter. In the following description, “%” represents “weight %”.

### EXAMPLE 1

The following composition (F/R=2.0) was thoroughly stirred and dispersed, to produce a coating dispersion of the ink receiving layer.

| | | |
|---|---|---|
| Water | 450 | parts by weight |
| (which will be referred to as “parts” | | |
| hereinafter) | | |
| Polyvinyl alcohol 5% aqueous solution | 500 | parts |
| (manufactured by Kuraray Co., “PVA 235”) | | |
| Microparticle silica | 50 | parts |
| (manufactured by Nippon Aerosil, | | |
| “Aerosil 300”, the average particle diameter | | |
| diameter of the primary particle is 7 nm, | | |
| BET specific surface area is 300 m²/g) | | |
| Dicyandiamide polycondensate | 25.0 | parts |
| (manufactured by Nikka Kagaku Co., | | |
| “Neofix E-117”) | | |
| Isopropyl alcohol | 66.7 | parts |

The coating dispersion described above was evenly applied, by coating with an applicator, on the surface of light blue colored woodfree paper as the substrate whose basis weight was 116.3 g/m², so that the dry weight of the coating was 3.4 g/m². The product was dried, whereby the sheet of Example 1 of the recording material of the present invention was obtained.

### EXAMPLE 2

A dispersion was prepared in a manner similar to that of Example 1 except that the content of polyvinyl alcohol (PVA) 5% aqueous solution was 285. 4 parts, the content of the dicyandiamide polycondensate was 14.8 parts, and F/R was 3.5. This dispersion was evenly applied, by coating with an applicator, on the surface of the substrate that is similar to that of Example 1 except that the dry weight of the coating was 3.0 g/m². The product was dried, whereby the sheet of Example 2 of the recording material of the present invention was obtained.

### EXAMPLE 3

A dispersion was prepared in a manner similar to that of Example 2 except that the content of polyvinyl alcohol (PVA) 5% aqueous solution was 166.5 parts and F/R was 6.0.

As the substrate, fancy paper, whose basis weight thereof was 116.3 g/m², which had been colored in a rosy color and emboss-processed so as to have stripe patters was employed. The coating dispersion prepared as described above was evenly applied, by coating with an applicator, on the surface of the fancy paper in a manner that the dry weight of the coating was 6.1 g/m². The product was dried, whereby the sheet of Example 3 of the recording material of the present invention was obtained.

### EXAMPLE 4

A coating dispersion was prepared in a manner similar to that of Example 2 except that “Aerosil 380” (manufactured by Nippon Aerosil Co.,) whose primary particle diameter is 7 nm and whose BET specific surface area is 380 m²/g was used instead of Aerosil 300. The other conditions of coating were exactly the same as those of Example 2. The product was dried, whereby the sheet of Example 4 of the recording material of the present invention was obtained.

### EXAMPLE 5

As the substrate, yellow colored woodfree paper whose basis weight was 157.0 g/m² was employed. The coating dispersion of Example 2 was evenly applied, by coating with an applicator, on the surface of the woodfree paper so that the dry weight of the coating was 9.5 g/m². The product was dried, whereby the sheet of Example 5 of the recording material of the present invention was obtained.

### Comparative Example 1

A dispersion was prepared in a manner similar to that of Example 2 except that the content of the polyvinyl alcohol (PVA) 5% aqueous solution was 1000 parts and F/R was 1.0. Other conditions of coating were similar to those of Example 2. The product was dried, whereby the sheet as the recording material of Comparative Example 1 was obtained.

### Comparative Example 2

A coating dispersion was prepared in a manner similar to that of Example 2 except that “Aerosil 200” (manufactured by Nippon Aerosil Co.,) whose primary particle diameter is 7 nm and whose BET specific surface area is 200 m²/g was used instead of Aerosil 300. Other conditions of coating were the same as those of Example 2. The product was dried, whereby the sheet as the recording material of Comparative Example 2 was obtained.

### Comparative Example 3

An experiment was carried out in a manner similar to that of Example 2 by using the same coating dispersion expect that the dry coating weight was 11.7 g/m². Other conditions of coating were exactly the same as those of Example 2. The product was dried, whereby the sheet as the recording material of Comparative Example 3 was obtained.

### Comparative Example 4

A coating dispersion was prepared in a manner similar to that of Example 2 except that an aqueous cationic amide resin (manufactured by Showa Kobunshi Co., “Polyfix 301”) was used instead of dicyandiamide polycondensate (“Neofix E-117”). Other conditions of coating were exactly the same as those of Example 2. The product was dried, whereby the sheet as the recording material of Comparative Example 4 was obtained.

Table 1 shows the following evaluation results observed in each of the recording material sheets obtained by the aforementioned Examples 1-5 and Comparative Examples 1-4;

“Reproducibility of color and patterns of the substrate surface”;

“Color development property” and “Setting property” when offset printing was performed on each sheet by using yellow, scarlet, dark blue and carbon-black inks of “Space Color GEOS-G” manufactured by DAINIPPON INK & CHEMICALS, INC. (i.e., printing inks for common paper);

“Surface strength property” measured by an IGT printing test machine.

Table 1 also shows the evaluation results of “ink absorption property”, “color-development property” and “water proof property of printing portions” when images were printed on each sheet by using an inkjet printer (manufactured by Epson Co., “PM-2000C).

TABLE 1

| | Reproducibility of | | | | Suitability for inkjet printing | | |
|---|---|---|---|---|---|---|---|
| | color, patterns of | Suitability for offset printing | | | Ink | Color | Water proof |
| | the substrate | Color development | | IGT surface | absorption | development | property of |
| | surface | property | Setting property | strength property | property | property | printing portion |
| Example 1 | ⊚ | ◯ | ◯ | ⊚ | ◯ | ◯ | ◯ |
| Example 2 | ⊚ | ⊚ | ⊚ | ⊚ | ⊚ | ⊚ | ⊚ |
| Example 3 | ⊚ | ⊚ | ⊚ | ◯ | ⊚ | ⊚ | ⊚ |
| Example 4 | ⊚ | ⊚ | ⊚ | ◯ | ⊚ | ⊚ | ◯ |
| Example 5 | ◯ | ◯ | ⊚ | ◯ | ⊚ | ⊚ | ⊚ |
| Comparative | ⊚ | Δ | Δ | ⊚ | X | Δ | X |
| Example 1 | | | | | | | |
| Comparative | ⊚ | ⊚ | ⊚ | ⊚ | Δ | Δ | Δ |
| Example 2 | | | | | | | |
| Comparative | Δ | X | ⊚ | X | ⊚ | ⊚ | ⊚ |
| Example 3 | | | | | | | |
| Comparative | X | Δ | Δ | ◯ | ⊚ | ◯ | ◯ |
| Example 4 | | | | | | | |

1. The suitability for inkjet printing was evaluated by using “Epson PM-2000C” as the evaluation device. Here, the evaluation patterns were evaluated for each of the following colors: Y (yellow); M (magenta); C (cyan); K (black); R (red); G (green); and B (blue).
2. Evaluation criteria
⊚ Excellent
◯ Good
Δ May cause problems in actual use
X Not good

From Table 1, it is understood that Comparative Examples 1 and 2 achieved excellent results in the reproducibility of colors and patterns of the substrate surface but had a problem in the inkjet printing property.

Further, Table 2 shows the measurement results of the opacity including the substrate of the sheets each prepared by: using a transparent Pet having thickness of 100 μm (manufactured by Toyobo co., “A-8300”) as the substrate; applying, by coating, each of the dispersions of Examples 1 to 5 and Comparative Examples 1 to 4 on the substrate surface and drying the product, so that the ink receiving layer of each sheet has the same dry weight as that of Example 1 to 5, Comparative Example 1 to 4, respectively.

TABLE 2

| | Dry weight of the ink | |
|---|---|---|
| | receiving layer (g/m²) | Opacity (%) |
| Transparent PET substrate | — | 15.7 |
| Example 1 | 3.4 | 15.0 |
| Example 2 | 3.0 | 14.4 |
| Example 3 | 6.1 | 15.3 |
| Example 4 | 3.0 | 15.0 |
| Example 5 | 9.5 | 15.9 |
| Comparative Example 1 | 3.0 | 13.0 |
| Comparative Example 2 | 3.0 | 15.9 |
| Comparative Example 3 | 11.7 | 16.9 |
| Comparative Example 4 | 3.0 | 14.6 |

What is claimed is:

1. A recording material in which an ink receiving layer containing, as main components, a binder resin and microparticle silica is provided on a substrate, wherein a ratio F/R, which is a ratio of a solid content weight F of the microparticle silica in the ink receiving layer to a solid content weight R of the binder resin, is in the range of 2.0 to 7.0 and a dicyandiamide polycondensate is contained in the ink receiving layer.

2. A recording material of claim 1, wherein the dycyandiamide polycondensate is a polyamine-based condensate.

3. A recording material of claim 1, wherein the average particle diameter of primary particles of microparticle silica is 10 nm or less and the value of specific surface area according to BET is in the range of 250 to 450 m²/g.

4. A recording material of claim 2, wherein the average particle diameter of primary particles of microparticle silica is 10 nm or less and the value of specific surface area according to BET is in the range of 250 to 450 m²/g.

5. A recording material of claim 1, wherein the binder resin is a polyvinyl alcohol resin.

6. A recording material of claim 2, wherein the binder resin is a polyvinyl alcohol resin.

7. A recording material of claim 3, wherein the binder resin is a polyvinyl alcohol resin.

8. A recording material of claim 4, wherein the binder resin is a polyvinyl alcohol resin.
